(19) United States
(12) Patent Application Publication
(10) Pub. No.: US 2016/0291394 A1
(43) Pub. Date: Oct. 6, 2016

(54) LIQUID CRYSTAL DISPLAY DEVICE AND METHOD OF MANUFACTURING THE SAME

(71) Applicant: Samsung Display Co., Ltd, Yongin-si (KR)

(72) Inventors: Lei Xie, Suwon-si (KR); Dae Ho YOON, Seoul (KR); Hyeong Gyu JANG, Asan-si (KR)

(21) Appl. No.: 14/977,179

(22) Filed: Dec. 21, 2015

(30) Foreign Application Priority Data
Apr. 1, 2015 (KR) 10-2015-0046218

(51) Int. Cl. G02F 1/1333; G02F 1/1341; G02F 1/1335; G02F 1/1337

(52) U.S. Cl. CPC G02F 1/133377; G02F 1/1337; G02F 1/1341; G02F 1/133514; G02F 1/133512

(57) ABSTRACT

A liquid crystal display device according to an exemplary embodiment of the present disclosure includes: a substrate; a thin film transistor disposed on the substrate; a pixel electrode connected to the thin film transistor; a first alignment layer disposed on the pixel electrode; a second alignment layer spaced apart from the first alignment layer by microcavities; and a roof layer disposed on the second alignment layer, in which the first alignment layer comprises a nano structure pattern layer.

### CROSS-REFERENCE TO RELATED APPLICATION

This application claims priority to and the benefit of Korean Patent Application No. 10-2015-0046218 filed in the Korean Intellectual Property Office on Apr. 1, 2015, the entire contents of which are incorporated herein by reference.

### BACKGROUND

(a) Field of the Disclosure

The present disclosure relates to a liquid crystal display device and a method of manufacturing the same.

(b) Description of the Related Art

Currently, display devices are required in widely used in computer monitors, televisions, mobile phones, and the like. The display device may be a cathode ray tube display device, a liquid crystal display, a plasma display device, or the like.

A liquid crystal display is a widely used type of flat panel displays and generally includes two display panels on which field-generating electrodes, such as a pixel electrode and a common electrode, are formed, and a liquid crystal layer interposed there between. By applying a voltage to the field generating electrodes to generate an electric field in the liquid crystal layer, the liquid crystal display determines the alignment of the liquid crystal molecules of the liquid crystal layer and thereby controls the polarization of incident light by the liquid crystal layer to display an image.

The two panels configuring the liquid crystal display may be formed of a thin film transistor array panel and an opposing panel. Gate lines transmitting a gate signal and data lines transmitting a data signal are formed to cross each other on the thin film transistor array panel. A thin film transistor connected to the gate line and the data line, a pixel electrode connected to the thin film transistor, and the like may also be formed on the thin film transistor array panel. A light blocking member, a color filter, a common electrode, and the like may be formed in the opposing panel. In some cases, the light blocking member, the color filter, and the common electrode may also be formed on the thin film transistor array panel.

However, in a liquid crystal display in the related art, because two substrates are used and constituent elements are formed on each of the two substrates, the display device is heavy and thick, the cost thereof is high, and the process time thereof is long.

The above information disclosed in this Background section is only for enhancement of understanding of the background of the disclosure and therefore may contain information that does not form the prior art that is already known in this country to a person of ordinary skill in the art.

### SUMMARY

The present disclosure provides a liquid crystal display device that is manufactured by using one substrate, thereby decreasing its weight, thickness, cost, and process time, and a method of manufacturing the same.

Further, the present disclosure provides a liquid crystal display device including an alignment layer having a uniform and predetermined thickness or more, a method of manufacturing the same.

An exemplary embodiment of the present disclosure provides a liquid crystal display device, including: a substrate; a thin film transistor disposed on the substrate; a pixel electrode connected to the thin film transistor; a first alignment layer disposed on the pixel electrode; a second alignment layer spaced apart from the first alignment layer by microcavities; and a roof layer disposed on the second alignment layer, in which the first alignment layer comprises a nano structure pattern layer.

The nano structure pattern layer may be comprised of a hydrophobic polymer.

The hydrophobic polymer may be polyethylene terephthalate, polyethylene naphthalate, polycarbonate, polyethersulfone, polycyclic olefin, polyacrylate, polyetheretherketone, and polyimide.

A thickness of the first alignment layer may be greater than a thickness of the second alignment layer.

A pattern of the nano structure may have a shape, in which a concave-convex form shaped like a cone, a parabola, or a pillar is regularly or irregularly arranged.

An interval of the patterns of the nano structure pattern layers may be a maximum of 300 nm.

The liquid crystal display device may further include: a liquid crystal injection hole formed in the common electrode and the roof layer so that a part of the microcavity is exposed; a liquid crystal layer filled in the microcavity; and a capping layer disposed on the roof layer to cover the liquid crystal injection hole, and configured to seal the microcavity.

The liquid crystal display device may further include: a color filter formed so as to overlap the pixel electrode; and a light blocking member formed so as to overlap the thin film transistor.

Another exemplary embodiment of the present disclosure provides a method of manufacturing a liquid crystal display device, including: forming a thin film transistor on a substrate; forming a pixel electrode connected to the thin film transistor; forming a nano structure pattern layer on the pixel electrode; forming a sacrificial layer on the nano structure pattern layer; forming a roof layer on the sacrificial layer; forming microcavities between the pixel electrode and the roof layer by removing the sacrificial layer; forming an alignment layer by injecting an alignment material into the microcavities; and forming a liquid crystal layer by injecting a liquid crystal material into the microcavities.

The nano structure pattern layer may be formed by at least one of a nano imprint lithography method, a polymer peeling method, an interference lithography method, and a block co-polymer direct self-assembly method.

The alignment layer includes: a first alignment layer comprising a nano structure pattern layer; and a second alignment layer spaced apart from the first alignment layer by microcavities.

The nano structure pattern layer may be comprised of a hydrophobic polymer.

The hydrophobic polymer may be polyethylene terephthalate, polyethylene naphthalate, polycarbonate, polyethersulfone, polycyclic olefin, polyacrylate, polyetheretherketone, and polyimide.

The method may further include: forming a common electrode on the sacrificial layer; forming a liquid crystal injection hole by patterning the roof layer and the common electrode, so that a part of the sacrificial layer is exposed; and forming a capping layer on the roof layer to seal the microcavities.

According to exemplary embodiments of the liquid crystal display device and the method of manufacturing the same, it is possible to reduce the weight, thickness, cost, and process time by manufacturing the display device using one substrate.

Further, the liquid crystal display device according to exemplary embodiments of the present disclosure provides an alignment layer having a uniform and sufficient thickness.

### BRIEF DESCRIPTION OF THE DRAWINGS

FIG. 1 is a top plan view illustrating a liquid crystal display according to an exemplary embodiment of the present disclosure.

FIG. 2 is a top plan view illustrating one pixel of the liquid crystal display device according to an exemplary embodiment of the present disclosure.

FIG. 3 is a cross-sectional view illustrating a part of the liquid crystal display device taken along line of FIG. 1 according to an exemplary embodiment of the present disclosure.

FIG. 4 is a cross-sectional view illustrating a part of the liquid crystal display device taken along line IV-IV of FIG. 1 according to an exemplary embodiment of the present disclosure.

FIGS. 5, 6, 7, 8, 9, 10 and 11 are cross-sectional views illustrating a method of manufacturing a liquid crystal display device according to an exemplary embodiment of the present disclosure.

### DETAILED DESCRIPTION OF THE EMBODIMENTS

The present system and method are described more fully hereinafter with reference to the accompanying drawings in which exemplary embodiments of the present system and method are shown. As those skilled in the art would realize, the described embodiments may be modified in various different ways, all without departing from the spirit or scope of the present disclosure.

In the drawings, the thickness of layers, films, panels, regions, etc., are exaggerated for clarity. Like reference numerals designate like elements throughout the specification. It will be understood that when an element, such as a layer, film, region, or substrate, is referred to as being “on” another element, it may be directly on the other element, or intervening elements may also be present. In contrast, when an element is referred to as being “directly on” another element, there are no intervening elements present.

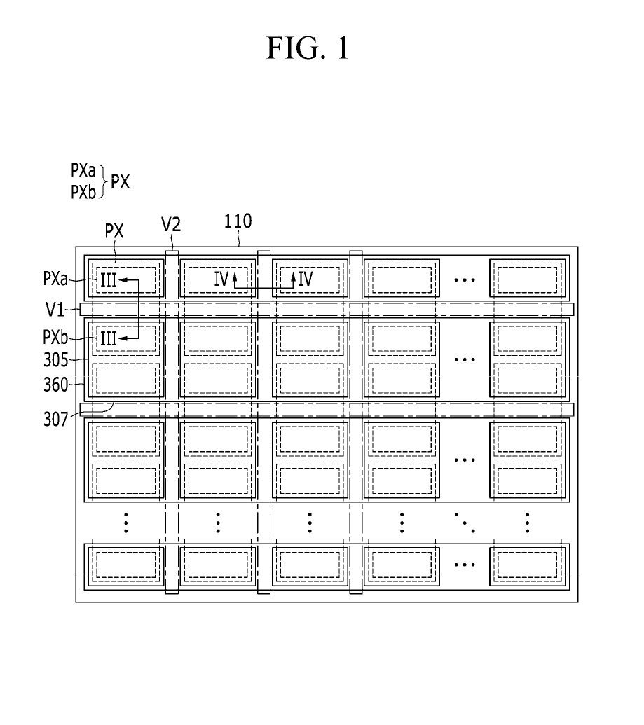

Hereinafter, a liquid crystal display device according to an exemplary embodiment of the present disclosure is described in detail with reference to FIGS. 1 to 4.

First, a liquid crystal display device according to an exemplary embodiment of the present disclosure is schematically illustrated with reference to FIG. 1. A liquid crystal display according to an exemplary embodiment of the present disclosure includes an insulating substrate 110 formed of glass, plastic, and the like, and roof layers 360 formed on the insulating substrate 110.

The insulating substrate 110 includes a plurality of pixel areas PX. The plurality of pixel areas PX is disposed in a matrix form including a plurality of pixel rows and a plurality of pixel columns. Each pixel area PX may include a first subpixel area PXa and a second subpixel area PXb. The first subpixel area PXa and the second subpixel area PXb may be vertically disposed.

A trench V1 may be formed at a part corresponding to a switching element, such as a thin film transistor, in the row direction of the pixels between the first subpixel area PXa and the second subpixel area PXb, where the roof layer 360 may be removed, and the trench may be filled with a capping layer, which is described below.

A plurality of microcavities 305 is formed in a display area of the liquid crystal display according to an exemplary embodiment of the present disclosure. Each of the plurality of microcavities 305 may be formed at a part corresponding to the pixel area. In the present exemplary embodiment, although it is described that the second subpixel area PXb of the upper pixel area and the first subpixel area PXa of the lower pixel area in two vertically adjacent pixel areas correspond to one microcavity 305, the microcavity 305 may be formed so as to correspond to one pixel area or two or more pixel areas.

A liquid crystal material enters the empty space inside the microcavity 305 to form a liquid crystal layer. The microcavity 305 is covered by the roof layer 360, so that a structure thereof may be maintained, and the roof layer 360 may be elongated in the row direction. In this case, the roof layer 360 is removed at a part corresponding to the trench V1, so that the roof layer 360 may be vertically separated by the trench V1.

Further, the part of the microcavity 305 where it contacts the trench V1 is not covered by the roof layer 360 and forms an area corresponding to an injection hole 307, which exposes the microcavity 305 to the outside. An alignment material and a liquid crystal material may be injected into the microcavity 305 through the injection hole 307. The injection hole 307 may be covered by a capping layer, which is described below. The roof layer 360 is formed to cover the remaining lateral surfaces of the microcavity 305, except for the injection hole 307. In this case, partition walls V2 having a structure covered with the roof layers 360 may be positioned between the microcavity 305 adjacent to each other in the row direction.

The aforementioned structure of the liquid crystal display device according to the exemplary embodiment of the present disclosure is just an example, and may be variously modified. For example, a disposition form of the pixel area PX, the trench V1, and the partition wall V2 may be modified, the plurality of roof layers 360 may be connected to each other at the trench V1, and the microcavity 305 may be formed in the partition wall V2 at a part of each roof layer 360, so that the microcavity 305 may also be connected with each other without the partition wall V2.

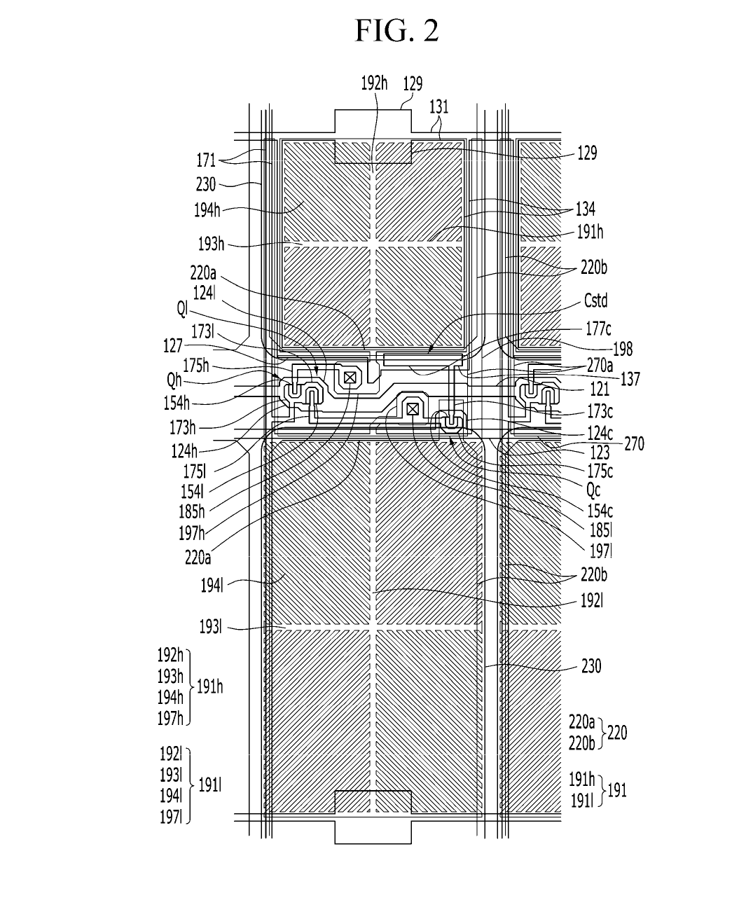

Next, one pixel of the liquid crystal display device according to an exemplary embodiment of the present disclosure is described with reference to FIGS. 2 to 4 together with FIG. 1.

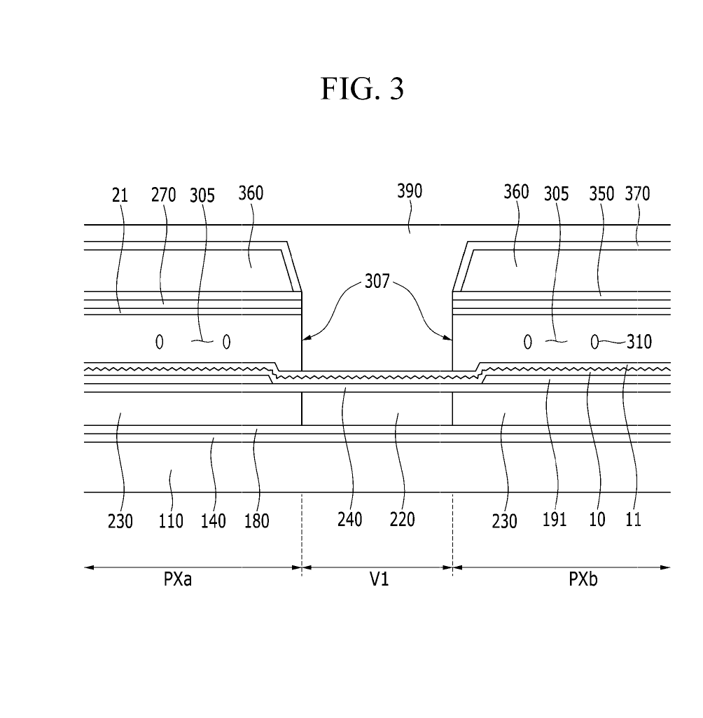

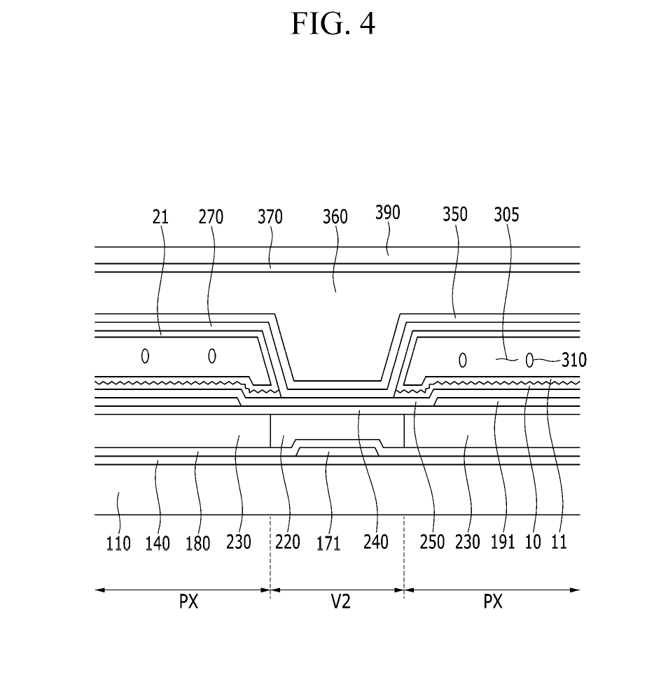

FIG. 2 is a top plan view illustrating one pixel of the liquid crystal display device according to an exemplary embodiment of the present disclosure. FIG. 3 is a cross-sectional view illustrating a part of the liquid crystal display device taken along line of FIG. 1 according to an exemplary embodiment of the present disclosure. FIG. 4 is a cross-sectional view illustrating a part of the liquid crystal display device taken along line IV-IV of FIG. 1 according to an exemplary embodiment of the present disclosure.

Referring to FIGS. 1 to 4, a plurality of gate conductors including a plurality of gate lines 121, a plurality of step-down gate lines 123, and a plurality of storage electrode lines 131 are formed on the substrate 110.

The gate line 121 and the step-down gate line 123 are extended mainly in a horizontal direction and transmit a gate signal. The gate conductors further include a first gate electrode 124h and a second gate electrode 124l protruding upwardly and downwardly from the gate line 121, and a third gate electrode 124c protruding upwardly from the step-down gate line 123. The first gate electrode 124h and the second gate electrode 124l are connected to each other to form one protrusion portion. In some cases, protrusion forms of the first, second, and third gate electrodes 124h, 124l, and 124c may be changed.

The storage electrode line 131 is also extended mainly in the horizontal direction and transmits a predetermined voltage, such as a common voltage Vcom. The storage electrode line 131 includes a storage electrode 129 that protrudes upwardly and downwardly, a pair of vertical portions 134 that extends downwardly to be substantially vertical to the gate line 121, and a horizontal portion 127 that connects ends of the pair of vertical portions 134 to each other. The horizontal portion 127 includes a capacitive electrode 137 that extends downwardly.

A gate insulating layer 140 is positioned on the gate conductors 121, 123, 124h, 124l, 124c, and 131. The gate insulating layer 140 may be formed of an inorganic insulating material, such as silicon nitride (SiNx) and silicon oxide (SiOx). Further, the gate insulating layer 140 may be formed of a single layer or a multilayer.

A first semiconductor 154h, a second semiconductor 154l, and a third semiconductor 154c are formed on the gate insulating layer 140. The first semiconductor 154h may be positioned on the first gate electrode 124h, the second semiconductor 154l may be positioned on the second gate electrode 124l, and the third semiconductor 154c may be positioned on the third gate electrode 124c. The first semiconductor 154h and the second semiconductor 154l may be connected to each other, and the second semiconductor 154l and the third semiconductor 154c may also be connected to each other. Further, the first semiconductor 154h may be formed to extend to a lower side of the data line 171. The first to third semiconductors 154h, 154l, and 154c may be formed of amorphous silicon, polycrystalline silicon, a metal oxide, or the like.

Ohmic contacts (not illustrated) may be further formed on the first to third semiconductor layers 154h, 154l, and 154c, respectively. The ohmic contacts may be made of a material, such as n+ hydrogenated amorphous silicon in which silicide or an n-type impurity is doped at a high concentration.

Data conductors including a data line 171, a first source electrode 173h, a second source electrode 173l, a third source electrode 173c, a first drain electrode 175h, a second drain electrode 175l, and a third drain electrode 175c are positioned on the first to third semiconductors 154h, 154l, and 154c.

The data line 171 transmits a data signal and extends mainly in a vertical direction to cross the gate line 121 and the step-down gate line 123. Each data line 171 includes the first source electrode 173h and the second source electrode 173l, which extend toward the first gate electrode 124h and the second gate electrode 124l and are connected with each other.

The first drain electrode 175h, the second drain electrode 175l, and the third drain electrode 175c include one wide end portion and one rod-shaped end portion. The rod-shaped end portions of the first drain electrode 175h and the second drain electrode 175l are partially surrounded by the first source electrode 173h and the second source electrode 173l. The one wide end portion of the second drain electrode 175l further extends to form the third source electrode 173c, which is bent in a U-shape. A wide end portion 177c of the third drain electrode 175c overlaps the capacitive electrode 137 to form a step-down capacitor Cstd, and the rod-shaped end portion thereof is partially surrounded by the third source electrode 173c.

The first gate electrode 124h, the first source electrode 173h, and the first drain electrode 175h form a first thin film transistor Qh together with the first semiconductor 154h. The second gate electrode 124l, the second source electrode 173l, and the second drain electrode 175l form a second thin film transistor Ql together with the second semiconductor 154l. The third gate electrode 124c, the third source electrode 173c, and the third drain electrode 175c form a third thin film transistor Qc together with the third semiconductor 154c.

The first semiconductor 154h, the second semiconductor 154l, and the third semiconductor 154c may be connected with each other to form a linear shape, and may have substantially the same planar shape as those of the data conductors 171, 173h, 173l, 173c, 175h, 175l, and 175c and the ohmic contacts therebeneath, including the channel regions between the source electrodes 173h, 173l, and 173c and the drain electrodes 175h, 175l, and 175c.

The first semiconductor layer 154h includes a portion that is not covered by the first source electrode 173h and the first drain electrode 175h and is exposed between the first source electrode 173h and the first drain electrode 175h. The second semiconductor layer 154l includes a portion that is not covered by the second source electrode 173l and the second drain electrode 175l and is exposed between the second source electrode 173l and the second drain electrode 175l. The third semiconductor layer 154c includes a portion that is not covered by the third source electrode 173c and the third drain electrode 175c and is exposed between the third source electrode 173c and the third drain electrode 175c.

A passivation layer 180 is positioned on the data conductors 171, 173h, 173l, 173c, 175h, 175l, and 175c, and the portions of the semiconductors 154h, 154l, and 154c that are exposed between the source electrodes 173h, 173l, and 173c and the drain electrodes 175h, 175l, and 175c, respectively. The passivation layer 180 may be formed of an organic insulating material or an inorganic insulating material, and formed of a single layer or a multilayer.

A color filter 230 is formed in each pixel area PX on the passivation layer 180. Each color filter 230 may display any one of the primary colors, such as three primary colors of red, green, and blue. The color filter 230 is not limited to the three primary colors of red, green and blue colors, and may display cyan, magenta, yellow, and white-based colors. In contrast to the illustration, the color filter 230 may be longitudinally extended in a column direction along a portion between the adjacent data lines 171.

A light blocking member 220 is formed in an area between the adjacent color filters 230. The light blocking member 220 may be formed on a boundary portion of the pixel areas PX and the thin film transistor to prevent light leakage. The color filter 230 may be formed in each first subpixel area PXa and each second subpixel area PXb, and the light blocking member 220 may be formed between the first subpixel area PXa and the second subpixel area PXb.

The light blocking member 220 includes a horizontal light blocking member 220a and a vertical light blocking member 220b. The horizontal light blocking member 220a extends in up and down directions along the gate line 121 and the step-down gate line 123 and covers the areas in which the first thin film transistor Qh, the second thin film transistor Ql, and the third thin film transistor Qc are positioned. The vertical light blocking member 220b extends along the data line 171. That is, a horizontal light blocking member 220a may be formed to overlap a trench V1, and a vertical light blocking member 220b may be formed to overlap a partition wall V2. The color filters 230 and the light blocking members 220 may also overlap each other in some areas.

A first insulating layer 240 may be further formed on the color filter 230 and the light blocking member 220. The first insulating layer 240 may be formed of an inorganic insulating material, such as silicon nitride (SiNx), silicon oxide (SiOx), and silicon oxide nitride (SiOxNy). The first insulating layer 240 serves to protect the color filters 230 and the light blocking members 220 formed of the organic material, and may be omitted in some cases.

A plurality of first contact holes 185h and a plurality of second contact holes 185l, through which the wide end portion of the first drain electrode 175h and the wide end portion of the second drain electrode 175l are exposed, respectively, are formed in the first insulating layer 240, the light blocking member 220, and the passivation layer 180.

A pixel electrode 191 is formed on the first insulating layer 240. The pixel electrode 191 may be formed of a transparent metal material, such as an indium tin oxide (ITO) and an indium zinc oxide (IZO).

The pixel electrode 191 includes a first subpixel electrode 191h and a second subpixel electrode 191l, which are separated from each other with the gate line 121 and the step-down gate line 123 interposed therebetween, and disposed in upper and lower portions of the pixel area PX with respect to the gate line 121 and the step-down gate line 123 to be adjacent to each other in the column direction. That is, the first subpixel electrode 191h and the second subpixel electrode 191l are separated from each other with the trench V1 interposed therebetween, and the first subpixel electrode 191h is positioned in the first subpixel area PXa, and the second subpixel electrode 191l is positioned in the second subpixel area Pxb.

The first subpixel electrode 191h and the second subpixel electrode 191l are connected with the first drain electrode 175h and the second drain electrode 175l through the first contact hole 185h and the second contact hole 185l, respectively. Accordingly, when the first thin film transistor Qh and the second thin film transistor Ql are in an on-state, the first subpixel electrode 191h and the second subpixel electrode 191l receive a data voltage from the first drain electrode 175h and the second drain electrode 175l.

A general shape of each of the first subpixel electrode 191h and the second subpixel electrode 191l is a quadrangle, and each of the first subpixel electrode 191h and the second subpixel electrode 191l includes cross-shaped stem portions formed by horizontal stem portions 193h and 193l and vertical stem portions 192h and 192l crossing the horizontal stem portions 193h and 193l, respectively. Further, the first subpixel electrode 191h and the second subpixel electrode 191l include a plurality of minute branch portions 194h and 194l and protrusion portions 197h and 197l protruding downwardly or upwardly from border sides of the subpixel electrodes 191h and 191l, respectively.

The subpixel electrodes 191h and 191l are each divided into four subareas by the horizontal stem portions 193h and 193l and the vertical stem portions 192h and 192l, respectively. The fine branch portions 194h and 194l obliquely extend from the horizontal stem portions 193h and 193l and the vertical stem portions 192h and 192l, and the extension direction thereof may form an angle of approximately 45° or 135° with respect to the gate line 121 or the horizontal stem portions 193h and 193l. Further, the directions in which the fine branch portions 194h and 194l in two adjacent subareas are extended may be orthogonal to each other.

In the present exemplary embodiment, the first subpixel electrode 191h further includes an outer peripheral stem portion surrounding an outer peripheral side thereof, and the second subpixel electrode 191l further includes horizontal portions positioned at an upper end and a lower end thereof, and left and right vertical portions 198 positioned at a left side and a right side of the first subpixel electrode 191h. The left and right vertical portions 198 may prevent capacitive coupling, for example, between the data line 171 and the first subpixel electrode 191h.

The disposition form of the pixel area, the structure of the thin film transistor, and the shape of the pixel electrode described above are just examples and may be variously modified. Thus, the present disclosure is not limited to the examples.

The common electrode 270 is formed on the pixel electrode 191 so as to be spaced apart from the pixel electrode 191 by a predetermined distance. The microcavity 305 is formed between the pixel electrode 191 and the common electrode 270. That is, the microcavity 305 is surrounded by the pixel electrode 191 and the common electrode 270. A width and an area of the microcavity 305 may be variously modified according to a size and resolution of the display device.

The common electrode 270 may be formed of a transparent metal material, such as an indium tin oxide (ITO) and an indium zinc oxide (IZO). A predetermined voltage may be applied to the common electrode 270, such that an electric field is formed between the pixel electrode 191 and the common electrode 270.

A first alignment layer 11 is formed on the pixel electrode 191. The first alignment layer 11 may also be formed on the first insulating layer 240 on which the pixel electrode 191 is not formed.

A nano structure pattern layer 10 is formed under the first alignment layer 11. Particularly, the nano structure pattern layer 10 may be positioned on the pixel electrode 191 and the first insulating layer 240.

The nano structure pattern layer 10 may be comprised of hydrophobic polymers. Particularly, the hydrophobic polymer may be polyethylene terephthalate (PET), polyethylene naphthalate (PEN), polycarbonate (PC), polyethersulf one (PES), polycyclic olefin (PCO), polyacrylate (PAR), polyetheretherketone (PEEK), and polyimide (PI). More particularly, the nano structure pattern layer 10 may be formed of a polymer having a flexible property.

Because the nano structure pattern layer 10 is formed under the first alignment layer 11, the liquid crystal display device has a uniform thickness due to a fixing force of the nano structure pattern, and it is possible to more thickly apply the alignment layer.

The nano structure pattern may be formed, for example, by one or more of a nano imprint lithography method, a polymer peeling method, an interference lithography method, and a block co-polymer direct self-assembly lithography method.

The nano imprint lithography method uses a technology of manufacturing a precise mold and forming a micro pattern at the nano level. Then, similar to stamping a seal, the micro pattern may be transferred to a thermoplastic resin or a photocurable resin that has been applied onto a substrate by applying pressure.

The polymer peeling method is a method of injecting a polymer into a micro patterned mold, cooling and hardening the polymer, separating the polymer from the mold, and attaching the separated polymer to a part that is to be nano-patterned. The interference lithography method is a lithography method in which a periodical linear pattern is formed by using an interference phenomenon generated between light. The block co-polymer directed self-assembly lithography method is a method of heat-treating or solvent-annealing a block co-polymer, and then selectively dry-etching one block among the co-polymers to form a pattern. The method of forming the nano structure pattern is not limited thereto.

In the repeated nano structure of the nano structure pattern layer 10, a concave-convex shape, such as a conical shape, a parabolic shape, and a pillar shape, may be regularly or irregularly formed. Particularly, the repeated pattern of the nano structure pattern layer 10 may be connected according to a position in which the first alignment layer 11 is formed, but the pattern is disconnected to be partially and independently formed.

An interval and a height of the patterns of the nano structure pattern layer 10 may be several tens of nanometers (nm) to several hundreds of nm. According to one embodiment, an interval and a height of the patterns of the nano structure may be a maximum of 300 nm.

According to an exemplary embodiment, the first alignment layer 11 is formed by applying an alignment material onto the nano structure pattern layer 10. In forming the first alignment layer 11, a hard bake process is performed after a pre-bake process. In this case, pinning force of the first alignment layer 11 comprising the nano structure pattern layer 10 is increased by a nano pattern surface, and thus it is possible to form the alignment layer having a uniform and predetermined thickness or more when applying the alignment material. The liquid crystal display device comprising the alignment layer having a predetermined thickness or more has an excellent voltage preservation rate, thereby providing the liquid crystal display device with excellent performance.

Accordingly, the first alignment layer 11 including the nano structure pattern layer 10 is formed to have a larger thickness than that of second alignment layers 21 spaced apart from each other by the microcavity. Particularly, the first alignment layer 11 having a thickness of about 10 nm or more may be formed.

The second alignment layer 21 is formed under the common electrode 270 so as to face the first alignment layer 11.

The first alignment layer 11 and the second alignment layer 21 may be formed as vertical alignment layers, and the first and second alignment layers 11 and 21 may be connected with each other at an edge of the pixel area PX.

A liquid crystal layer formed of liquid crystal molecules 310 is formed in the microcavity 305 positioned between the pixel electrode 191 and the common electrode 270. The liquid crystal molecules 310 may have negative dielectric anisotropy. Meaning the liquid crystal molecules 310 may be oriented with their long axis in a vertical direction to the substrate 110 when no electric field is applied. That is, vertical alignment may be implemented.

The first subpixel electrode 191h and the second subpixel electrode 191l, to which the data voltage is applied, generate an electric field together with the common electrode 270 to determine the orientation direction of the liquid crystal molecules 310 positioned in the microcavity 305 between the two electrodes 191 and 270. Luminance of light passing through the liquid crystal layer is changed according to the orientation direction of the liquid crystal molecules 310 determined as described above.

A second insulating layer 350 may be positioned on the common electrode 270. The second insulating layer 350 may be formed of an inorganic insulating material, such as a silicon nitride (SiNx), a silicon oxide (SiOx), a silicon nitride oxide (SiOxNy), and may be omitted in some cases.

The roof layer 360 is formed on the second insulating layer 350. The roof layer 360 may be formed of an organic material. The microcavity 305 is formed under the roof layer 360, and the roof layer 360 may be hardened by a hardening process to maintain the shape of the microcavity 305. That is, the roof layer 305 is formed to be spaced apart from the pixel electrode 191 with the microcavity 360 interposed therebetween.

The roof layer 360 is formed in each pixel area PX and the partition wall V2 along the pixel row but is not formed in the trench V1. That is, the roof layer 360 is not formed between the first subpixel area PXa and the second subpixel area PXb. The microcavity 305 is formed under each roof layer 360 in each first subpixel area PXa and each second subpixel area PXb. The microcavity 305 is not formed under the roof layer 360 in the partition wall V2, and an upper surface and both side surfaces of the microcavity 305 may be covered by the roof layer 360.

Because the roof layers 360 are not formed in the trench V1, the roof layers 360 are spaced apart from each other with the trench area interposed therebetween. Accordingly, the roof layer 360 in an area adjacent to the trench V1 has an inclined surface.

The injection hole 307 exposing a part of the microcavity 305 is formed in the common electrode 270, the second insulating layer 350, and the roof layer 360. The injection holes 307 may be formed to face each other at edges of the first subpixel area PXa and the second subpixel area PXb. That is, the injection hole 307 may be formed to expose side surfaces of the microcavity 305 corresponding to a lower side of the first subpixel area PXa and an upper side of the second subpixel area PXb. Because the microcavity 305 is exposed by the injection hole 307, an alignment material, a liquid crystal material, or the like may be injected into the microcavity 305 through the injection hole 307.

A capping layer 390 may be formed on the third insulating layer 370. The capping layer 390 is formed to cover the injection hole 307 through which a part of the microcavity 305 is otherwise exposed to the outside. That is, the capping layer 390 seals the microcavity 305 so as to prevent the liquid crystal molecules 310 in the microcavity 305 from being discharged to the outside. Since the capping layer 390 is in contact with the liquid crystal molecules 310, the capping layer 390 may be formed of a material that does not react with the liquid crystal molecules 310. For example, the capping layer 390 may be formed of parylene or the like.

The capping layer 390 may also be formed of a multilayer, such as a double layer or a triple layer. The double layer is formed of two layers of different materials. The triple layer is formed of three layers in which materials of the adjacent layers are different from each other. For example, the capping layer 390 may include a layer formed of an organic insulating material and a layer formed of an inorganic insulating material.

Although not illustrated in the drawings, polarizing plates may be further formed on upper and lower surfaces of the display device. The polarizing plates may be formed of a first polarizing plate and a second polarizing plate. The first polarizing plate may be attached onto a lower surface of the substrate 110, and the second polarizing plate may be attached onto the capping layer 390.

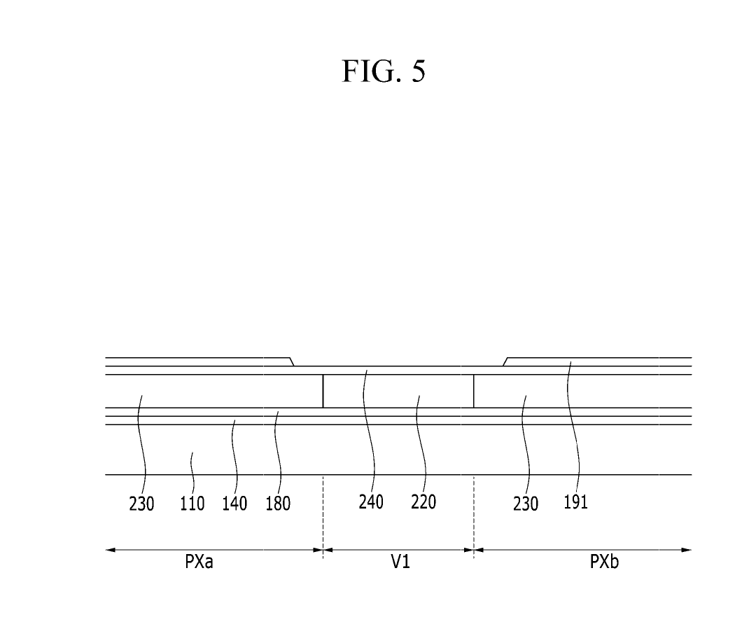

Next, a method of manufacturing a display device according to an exemplary embodiment of the present disclosure is described below with reference to FIGS. 5 to 11. Further, a method of manufacturing a display device according to an exemplary embodiment of the present disclosure is also described with reference to FIGS. 1 to 4.

FIGS. 5 to 11 are cross-sectional views illustrating a method of manufacturing a liquid crystal display device according to an exemplary embodiment of the present disclosure.

First, as illustrated in FIG. 5, gate lines 121 and step-down gate lines 123 extending in one direction are formed on an insulating substrate 110 formed of glass, plastic, or the like, and a first gate electrode 124h, a second gate electrode 124l, and a third gate electrode 124c protruding from the gate line 121 are formed.

Further, storage electrode lines 131 may be formed together with but spaced apart from the gate lines 121, the step-down gate lines 123, and the first to third gate electrodes 124h, 124l, and 124c.

Subsequently, a gate insulating layer 140 is formed on an entire surface of the substrate 110 including the gate lines 121, the step-down gate lines 123, the first to third gate electrodes 124h, 124l, and 124c, and the storage electrode lines 131 by using an inorganic insulating material, such as a silicon oxide (SiOx) or a silicon nitride (SiNx). The gate insulating layer 140 may be formed of a single layer or a multilayer.

Subsequently, a first semiconductor 154h, a second semiconductor 154l, and a third semiconductor 154c are formed by depositing a semiconductor material, such as amorphous silicon, polycrystalline silicon, or a metal oxide, on the gate insulating layer 140, and then patterning the deposited semiconductor material. The first semiconductor 154h may be formed to be positioned on the first gate electrode 124h, the second semiconductor 154l may be formed to be positioned on the second gate electrode 124l, and the third semiconductor 154c may be formed to be positioned on the third gate electrode 124c.

Subsequently, data lines 171 extending in another direction are formed by depositing a metal material and then patterning the metal material. The metal material may be formed of a single layer or a multilayer.

Further, a first source electrode 173h protruding from the data line 171 above the first gate electrode 124h, and a first drain electrode 175h spaced apart from the first source electrode 173h are formed together. Further, a second source electrode 173l connected with the first source electrode 173h, and a second drain electrode 175l spaced apart from the second source electrode 173l are formed together. Further, a third source electrode 173c extended from the second drain electrode 175l, and a third drain electrode 175c spaced apart from the third source electrode 173c are formed together.

The first to third semiconductors 154h, 154l, and 154c, the data lines 171, the first to third source electrodes 173h, 173l, and 173c, and the first to third drain electrodes 175h, 175l, and 175c may also be formed by continuously depositing a semiconductor material and a metal material and then patterning the materials at the same time. In this case, the first semiconductor 154h is formed to be extended to a lower side of the data lines 171.

The first, second, and third gate electrodes 124h, 124l, and 124c, the first, second, and third source electrodes 173h, 173l, and 173c, and the first, second, and third drain electrodes 175h, 175l, and 175c configure the first, second, and third thin film transistors (TFT) Qh, Ql, and Qc together with the first, second, and third semiconductors 154h, 154l, and 154c, respectively.

Next, passivation layers 180 are formed on the data lines 171, the first to third source electrodes 173h, 173l, and 173c, the first to third drain electrodes 175h, 175l, and 175c, and the semiconductors 154h, 154l, and 154c exposed between the first to third source electrodes 173h, 173l, and 173c and the first to third drain electrodes 175h, 175l, and 175c, respectively,

The passivation layer 180 may be formed of an organic insulating material or an inorganic insulating material, and formed of a single layer or a multilayer.

Subsequently, a color filter 230 is formed in each pixel area PX on the passivation layer 180. The color filter 230 may be formed in each first subpixel area PXa and each second subpixel area PXb, and may not be formed in the trench V1. Further, the color filters 230 having the same color may be formed in a column direction of the plurality of pixel areas PX. In the case where the color filters 230 having three colors are formed, after the color filter 230 having a first color is first formed, the color filter 230 having a second color may be formed by shifting a mask. Subsequently, after the color filter 230 having the second color is formed, the color filter having a third color may be formed by shifting the mask.

Subsequently, a light blocking member 220 is formed on a boundary portion of each pixel area PX on the passivation layer 180 and the thin film transistor. The light blocking member 220 may also be formed in the trench V1 positioned between the first subpixel area PXa and the second subpixel area PXb.

In the above, it is described that after the color filter 230 is formed, the light blocking member 220 is formed, but the present disclosure is not limited thereto, and the color filter 230 may be formed after the light blocking member 220 is formed.

Subsequently, a first insulating layer 240 is formed of an inorganic insulating material, such as a silicon nitride (SiNx), a silicon oxide (SiOx), and a silicon nitride oxide (SiOxNy) on the color filters 230 and the light blocking members 220.

Subsequently, a first contact hole 185h is formed so that a part of the first drain electrode 175h is exposed, and a second contact hole 185l is formed so that a part of the second drain electrode 175l is exposed by etching the passivation layer 180, the light blocking member 220, and the first insulating layer 240.

Next, the first subpixel electrode 191h is formed within the first subpixel area PXa and the second subpixel electrode 191l is formed within the second subpixel area PXb by depositing a transparent metal material, such as an indium-tin oxide (ITO) and an indium-zinc oxide (IZO), on the first insulating layer 240 and then patterning the transparent metal material. The first subpixel electrode 191h and the second subpixel electrode 191l are separated with the trench V1 interposed therebetween. The first subpixel electrode 191h is formed to be connected to the first drain electrode 175h through the first contact hole 185h, and the second subpixel electrode 191l is formed to be connected to the second drain electrode 175l through the second contact hole 185l.

The first subpixel electrode 191h and the second subpixel electrode 191 are provided with horizontal stem portions 193h and 193l and vertical stem portions 192h and 192l crossing the horizontal stem portions 193h and 193l, respectively. Further, a plurality of fine branch portions 194h and 194l is formed to obliquely extend from the horizontal stem portions 193h and 193l and the vertical stem portions 192h and 192l.

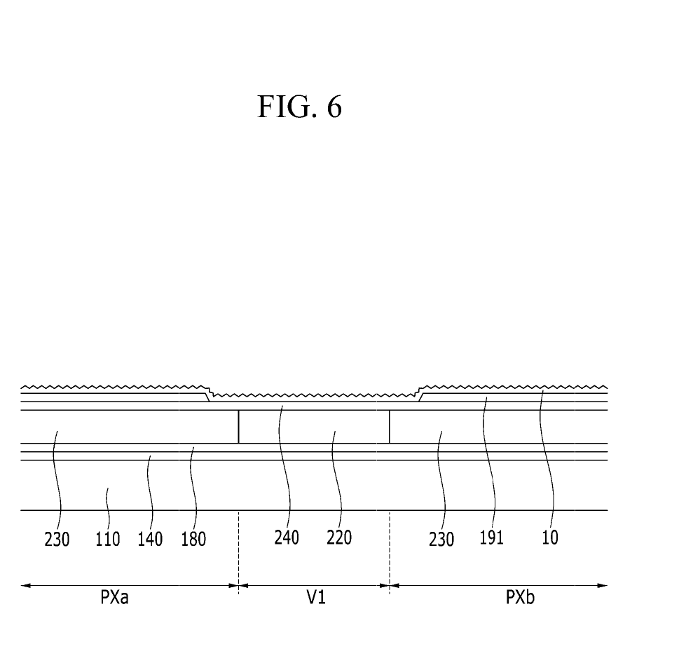

As illustrated in FIG. 6, a nano structure pattern layer 10 is formed, such by applying a hydrophobic polymer onto the pixel electrode 191 and performing a nano imprint lithography process. In other cases, the nano structure pattern layer 10 may be formed by one or more of the polymer peeling method, the interference lithography method, and a block co-polymer direct self-assembly lithography method, which have been described above.

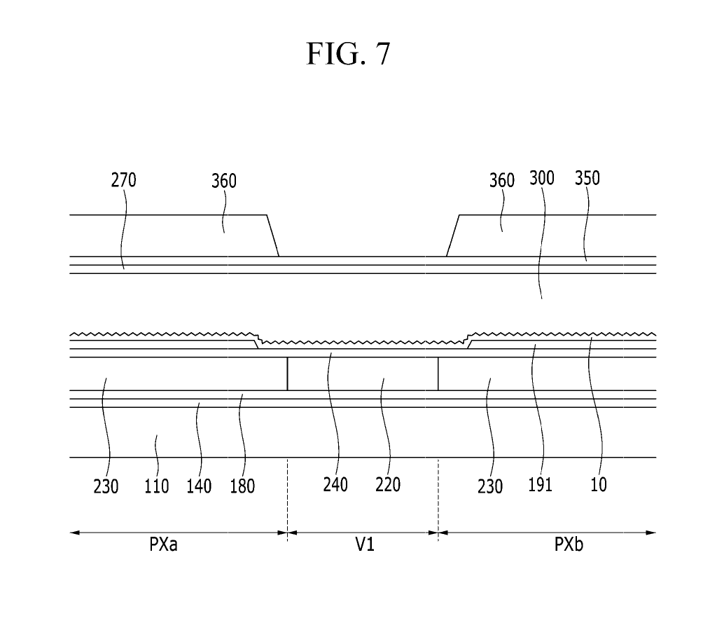

Referring to FIG. 7, after the nano structure pattern layer 10 is formed, a photosensitive organic material is applied onto the pixel electrode 191, on which the nano structure pattern layer 10 is formed, and a sacrificial layer 300 is formed through a photo process.

The sacrificial layer 300 is formed to be connected along a plurality of pixel columns.

Next, a common electrode 270 is formed by depositing a transparent metal material, such as an indium tin oxide (ITO) and an indium-zinc oxide (IZO), on the sacrificial layer 300.

Next, a second insulating layer 350 may be formed of an inorganic insulating material, such as a silicon nitride (SiNx), a silicon oxide (SiOx), and a silicon nitride oxide (SiOxNy), on the common electrode 270.

Next, roof layers 360 are formed by applying an organic material onto the second insulating layer 350, and patterning and removing the organic material positioned in a part corresponding to the trench V1, which is described below. Accordingly, the roof layers 360 may be connected along the plurality of pixel rows.

Because the roof layers 360 are not formed in or are removed from the trench area, the roof layers 360 are spaced apart from each other with the trench area interposed therebetween. Accordingly, the roof layer in the area adjacent to the trench area is formed to have an inclined surface.

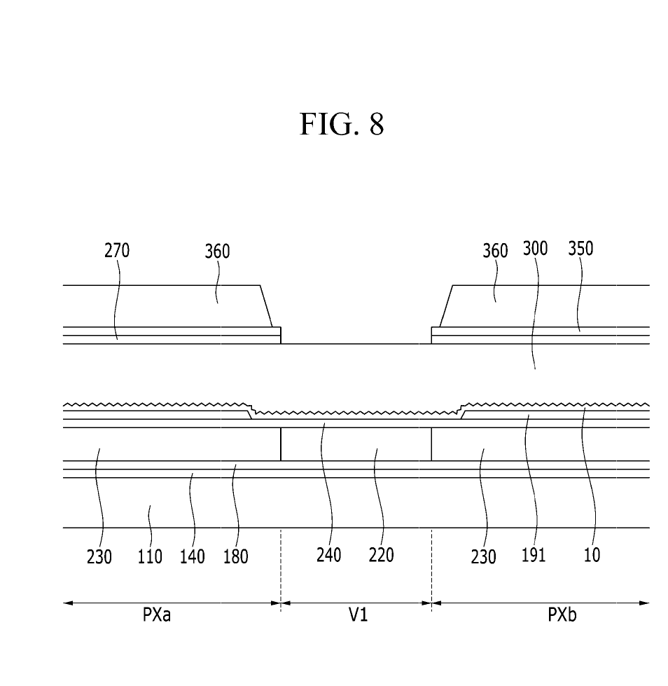

Next, as illustrated in FIG. 8, the second insulating layer 350 and the common electrode 270 are patterned by using the roof layer 360 as a mask. First, the second insulating layer 350 is dry etched by using the roof layer 360 as a mask, and then the common electrode 270 is wet etched.

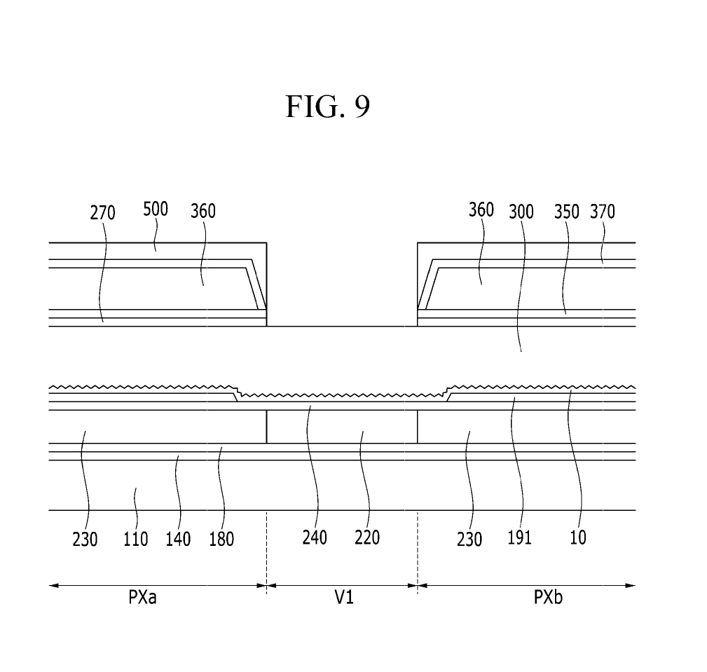

Next, as illustrated in FIG. 9, a third insulating layer 370 may be formed of an inorganic insulating material, such as a silicon nitride (SiNx), a silicon oxide (SiOx), and a silicon nitride oxide (SiOxNy), on the roof layer 360.

Next, a photo resist 500 is applied onto the third insulating layer 370, and the photo resist 500 is patterned through the photo process. In this case, it is possible to remove the photo resist 500 positioned in the trench V1. The third insulating layer 370 is etched by using the patterned photo resist 500 as a mask. That is, the third insulating layer 370 positioned in the trench V1 is removed.

The third insulating layer 370 is formed to cover an upper surface and lateral surfaces of the roof layer 360 to serve to protect the roof layer 360. A pattern of the third insulating layer 370 may be positioned at an outer side of a pattern of the roof layer 360.

A pattern of the second insulating layer 350 may be the same as the pattern of the third insulating layer 370. By contrast, the pattern of the second insulating layer 350 may also be positioned at an inner side of the pattern of the roof layer 360. In this case, the third insulating layer 370 may be formed to be in contact with the second insulating layer 350.

In the above, a facility patterning the roof layer 360 may be different from a facility patterning the third insulating layer 370, and a difference between the patterns of the third insulating layer 370 and the roof layer 360 may be increased due to an alignment error between the facilities. In such case, the part in which the pattern of the third insulating layer 370 is positioned at the outer side of the pattern of the roof layer 360 may fall or be broken. However, because the third insulating layer 370 is not a conductive member, a problem, such as a short-circuit with the pixel electrode 191, is not generated.

In the above, the process of forming the third insulating layer 370 is described, but the present disclosure is not limited thereto, and the third insulating layer 370 may not be formed. When the third insulating layer 370 is not formed, it is possible to prevent a problem generated due to an alignment error between the facility patterning the roof layer 360 and the facility patterning the third insulating layer 370.

Further, the second insulating layer 350 and the common electrode 270 are patterned by using the roof layer 360 as the mask, so that the alignment error is not generated.

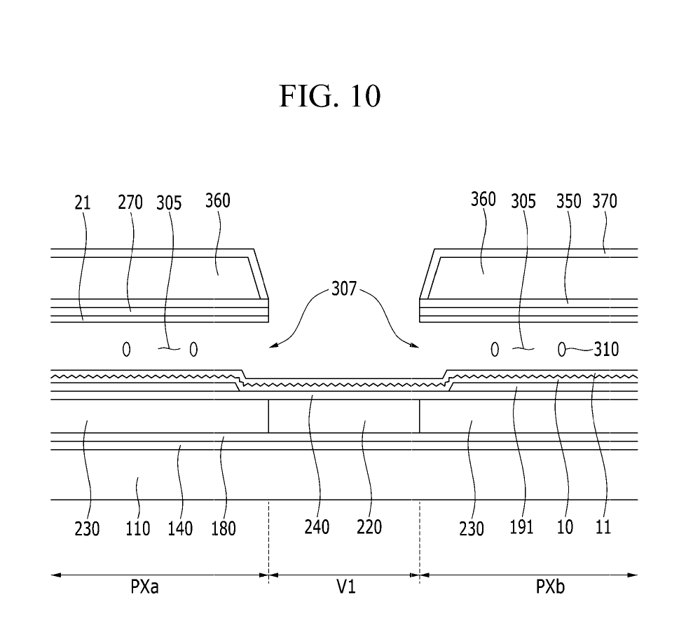

As illustrated in FIG. 10, the sacrificial layer 300 is totally removed by supplying a developer or a stripper agent to the substrate 110, in which the sacrificial layer 300 is exposed, or by using an ashing process.

When the sacrificial layer 300 is removed, microcavities 305 are formed where the sacrificial layer 300 was positioned.

The pixel electrode 191 and the common electrode 270 are spaced apart from each other with the microcavities 305 interposed therebetween, and the pixel electrode 191 and the roof layer 360 are spaced apart from each other with the microcavities 305 interposed therebetween. The common electrode 270 and the roof layer 360 are formed to cover an upper surface and both lateral surfaces of the microcavity 305.

The microcavity 305 is exposed to the outside through a portion in which the roof layer 360, the second insulating layer 350, and the common electrode 270 are removed, which is called an injection hole 307. The injection hole 307 is formed along the trench V1. For example, the injection holes 307 may be formed to face each other at edges of the first subpixel area PXa and the second subpixel area PXb. That is, the injection hole 307 may be formed to expose side surfaces of the microcavity 305 corresponding to a lower side of the first subpixel area PXa and an upper side of the second subpixel area PXb. In other embodiments, the injection hole 307 may also be formed along a partition wall V2.

Subsequently, the roof layer 360 is hardened by applying heat to the substrate 110. This is for the purpose of maintaining the shape of the microcavity 305 by the roof layer 360.

Subsequently, when an alignment solution including an alignment material is dropped on the substrate 110 by a spin coating manner or an inkjet manner, the alignment solution is injected into the microcavity 305 through the injection hole 307. When a hardening process is performed after the aligning solution is injected into the microcavity 305, a solution component is vaporized, and the alignment material remains on an inner wall surface of the microcavity 305.

Through the aforementioned process, a first alignment layer 11 may be formed on the pixel electrode 191, and a second alignment layer 21 may be formed under the common electrode 270. The first alignment layer 11 and the second alignment layer 21 are formed to face each other with the microcavity 305 interposed therebetween, and are formed to be connected to each other at the edge of the pixel area PX. The first alignment layer 11 including the nano structure pattern layer 10 is thicker than the second alignment layer 21 due to the nano pattern formed of the hydrophobic polymer. This results from a pinning force of the nano pattern.

In this case, the first and second alignment layers 11 and 21 may be aligned in a direction that is vertical to the substrate 110, except for the lateral surface of the microcavity 305. The first and second alignment layers 11 and 21 may be aligned in a direction that is horizontal to the substrate 110 by performing a process of additionally irradiating UV to the first and second alignment layers 11 and 21.

Subsequently, when a liquid crystal material formed of liquid crystal molecules 310 is dropped on the substrate 110 by an inkjet manner or a dispensing manner, the liquid crystal material is injected into the microcavity 305 through the injection hole 307. In this case, the liquid crystal material may be dropped onto the liquid crystal injection hole 307 formed along odd numbered trenches V1, and may not be dropped onto the liquid crystal injection hole 307 formed along even numbered trenches V1. In another case, the liquid crystal material may be dropped onto the liquid crystal injection hole 307 formed along even numbered trenches V1, and may not be dropped onto the liquid crystal injection hole 307 formed along odd numbered trenches V1.

When the liquid crystal material is dropped onto the liquid crystal injection hole 307 formed along the odd numbered trenches V1, the liquid crystal material enters the microcavity 305 through the injection hole 307 by capillary force. In this case, air within the microcavity 305 is discharged through the injection hole 307 formed along the even numbered trenches V1, and thus the liquid crystal material enters the microcavity 305.

Further, the liquid crystal material may also be dropped onto all of the injection holes 307. That is, the liquid crystal material may be dropped onto all of the injection holes 307 formed along the odd numbered trenches V1 and the injection holes 307 formed along the even numbered valleys V1.

As described above, when the liquid crystal material is injected into the microcavity by capillary force, the liquid crystal material dropped onto the injection hole is partially in contact with the roof layer, and thus may remain on the roof layer. Accordingly, the roof layer having a large thickness and a small angle according to an exemplary embodiment of the present disclosure may decrease the liquid crystal material remaining on the roof layer, thereby decreasing a pixel defect.

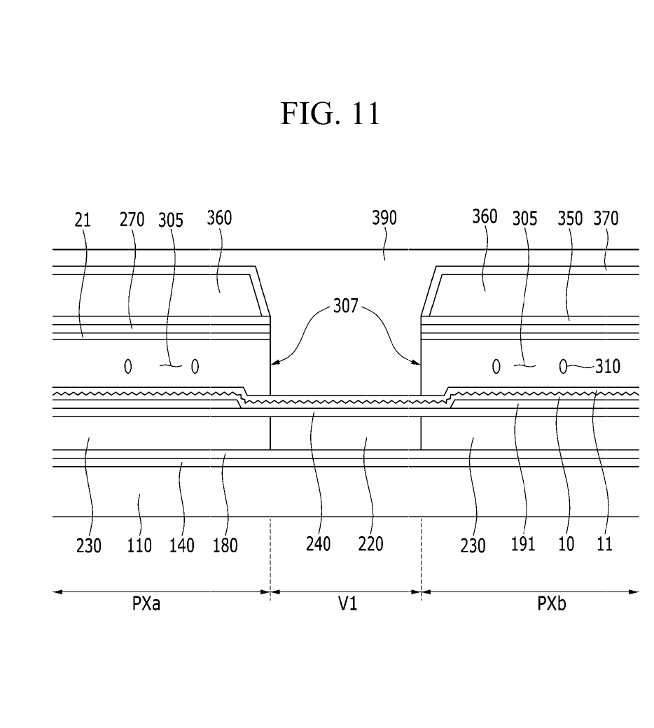

As illustrated in FIG. 11, a capping layer 390 is formed by depositing a material that does not react with the liquid crystal molecules 310 on the third insulating layer 370. The capping layer 390 is formed to cover the injection hole 307, through which the microcavity 305 would otherwise be exposed to the outside, to seal the microcavity 305.

Subsequently, although not illustrated in the drawings, polarizing plates may be further attached onto upper and lower surfaces of the display device. The polarizing plate may include a first polarizing plate a second polarizing plate. The first polarizing plate may be attached onto a lower surface of the substrate 110, and the second polarizing plate may be attached onto the capping layer 390.

While the present system and method have been described in connection with exemplary embodiments, it is to be understood that the present system and method are not limited to the disclosed embodiments. On the contrary, the present system and method are intended to cover various modifications and equivalent arrangements included within the spirit and scope of the appended claims.

What is claimed is:

1. A liquid crystal display device, comprising:
a substrate;
a thin film transistor disposed on the substrate;
a pixel electrode connected to the thin film transistor;
a first alignment layer disposed on the pixel electrode;
a second alignment layer spaced apart from the first alignment layer by microcavities; and
a roof layer disposed on the second alignment layer,
wherein the first alignment layer comprises a nano structure pattern layer.

2. The liquid crystal display device of claim 1, wherein:
the nano structure pattern layer comprises of a hydrophobic polymer.

3. The liquid crystal display device of claim 2, wherein:
the hydrophobic polymer is polyethylene terephthalate, polyethylene naphthalate, polycarbonate, polyethersulfone, polycyclic olefin, polyacrylate, polyetheretherketone, and polyimide.

4. The liquid crystal display device of claim 3, wherein:
a thickness of the first alignment layer is greater than a thickness of the second alignment layer.

5. The liquid crystal display device of claim 1, wherein:
a pattern of the nano structure pattern layer has a shape, in which a concave-convex form shaped like a cone, a parabola, or a pillar is regularly or irregularly arranged.

6. The liquid crystal display device of claim 5, wherein:
an interval of the patterns of the nano structure pattern layers is a maximum of 300 nm.

7. The liquid crystal display device of claim 1, further comprising:
a liquid crystal injection hole disposed in the common electrode and the roof layer so that a part of the microcavity is exposed;
a liquid crystal layer filled in the microcavity; and
a capping layer disposed on the roof layer to cover the liquid crystal injection hole and seal the microcavity.

8. The liquid crystal display device of claim 7, further comprising:
a color filter formed so as to overlap the pixel electrode; and
a light blocking member formed so as to overlap the thin film transistor.

9. A method of manufacturing a liquid crystal display device, comprising:
forming a thin film transistor on a substrate;
forming a pixel electrode connected to the thin film transistor;
forming a nano structure pattern layer on the pixel electrode;
forming a sacrificial layer on the nano structure pattern layer;
forming a roof layer on the sacrificial layer;
forming microcavities between the pixel electrode and the roof layer by removing the sacrificial layer;
forming an alignment layer by injecting an alignment material into the microcavities; and
forming a liquid crystal layer by injecting a liquid crystal material into the microcavities.

10. The method of claim 9, wherein:
the nano structure pattern layer is formed by at least one of
a nano imprint lithography method, a polymer peeling method, an interference lithography method, and a block co-polymer direct self-assembly method.

11. The method of claim 10, wherein:
the alignment layer includes: a first alignment layer comprising a nano structure pattern layer; and
a second alignment layer spaced apart from the first alignment layer by microcavities.

12. The method of claim 11, wherein:
the nano structure pattern layer is comprised of a hydrophobic polymer.

13. The method of claim 12, wherein:
the hydrophobic polymer is polyethylene terephthalate, polyethylene naphthalate, polycarbonate, polyethersulfone, polycyclic olefin, polyacrylate, polyetheretherketone, and polyimide.

14. The method of claim 13, further comprising:
forming a common electrode on the sacrificial layer;
forming a liquid crystal injection hole by patterning the roof layer and the common electrode so that a part of the sacrificial layer is exposed; and
forming a capping layer on the roof layer to seal the microcavities.
